(19) United States
(12) Patent Application Publication
(10) Pub. No.: US 2026/0046152 A1
(43) Pub. Date: Feb. 12, 2026

(54) METHOD AND APPARATUS FOR INDIVIDUALLY ASSIGNING AT LEAST ONE VEHICLE FUNCTION SCHEME TO AT LEAST ONE VEHICLE

(71) Applicant: MERCEDES-BENZ GROUP AG, Stuttgart (DE)

(72) Inventors: Mark GERBAN, Hamburg (DE); Michael ENGEL, Stuttgart (DE)

(21) Appl. No.: 19/140,686

(22) PCT Filed: Dec. 5, 2023
(86) PCT No.: PCT/EP2023/084313

§ 371 Date: Jun. 18, 2025

(30) Foreign Application Priority Data
Dec. 20, 2022 (DE) 10 2022 004 820.5

(51) Int. Cl. H04L 9/00

(52) U.S. Cl. CPC H04L 9/50; H04L 2209/84

(57) ABSTRACT

At least one vehicle function scheme is individually assigned to at least one vehicle. A vehicle function scheme is digitally recorded and is minted as a non-fungible token (NFT) in a predetermined number in a distributed ledger technology system, which assigns at most one vehicle to an NFT in each case. At least one NFT is selected and purchased for a vehicle. The vehicle function scheme assigned to the selected and purchased NFT is used.

### BACKGROUND AND SUMMARY OF THE INVENTION

Exemplary embodiments of the invention relate to a method for individually assigning at least one vehicle function scheme to at least one vehicle, as well as to an apparatus for carrying out such a method.

US 2012/0317161 A1 describes an in-vehicle computer system with instructions that cause a processor to store a media profile of a first user indicating the user's media preferences. The processor further determines when the vehicle encounters a second vehicle and receives a media profile of a second user. Furthermore, the processor evaluates the profiles to determine a similarity between them. If a similarity has been determined, recommended media is identified based on the characteristics of the profiles and the provision of recommended media to one of the user of the first vehicle and the user of the second vehicle is triggered.

US 2013/0124009 A1 describes a device and a method for managing vehicle configurations. A database with several configuration templates is provided. A configuration template comprises parameters of configurable features and settings of an associated vehicle. A configuration application allows a user to retrieve and customize a configuration template. Customized configuration data is transmitted to a control module of the vehicle to adjust features and settings in accordance with the user's configuration data.

US 2017/0369052 A1 describes a device and a method for controlling an autonomous vehicle. The method comprises receiving a profile selection by an electronic processor of the autonomous vehicle. The method further comprises receiving a driver profile having a plurality of settings based on the profile selection. The method further comprises, in an autonomous driving mode, steering with the electronic processor based on at least one of the plurality of settings.

Exemplary embodiments of the invention are directed to an improved method for individually assigning at least one vehicle function scheme to at least one vehicle, as well as to an apparatus for carrying out this method.

The user experience, i.e., the perception of multimedia content, but also the perception of the vehicle operation by a vehicle occupant, is influenced in modern vehicles by a large number of freely selectable parameters. The optimal design of such a user experience is complex and offers added value compared to standardized settings. There is therefore a need for a method that can be used to control the transmission of such customized settings and, in particular, to prevent any duplication by assigning customized settings to an individual (i.e., identifiable) vehicle.

In a method for individually assigning at least one vehicle function scheme to at least one vehicle, according to a first aspect of the invention, a vehicle function scheme is digitally recorded, for example as a set of integer values, floating point values, characters, character strings, binary data, and/or control instructions. A vehicle function schema digitally recorded in this way, for example encoded in a marking language such as XML (extensible mark-up language) or JavaScript Object Notation (JSON), is minted according to the invention as a non-fungible token (NFT) in a predetermined number in a distributed ledger technology (DLT) system.

In this context, ‘minting’ refers to the individualization and registration of digital data records. In other words, the DLT system manages individualized vehicle function schemes (e.g. via assigned numbers or character strings that are unique within the DLT system) and can assign these to other entities, such as users, organizations, vehicles, or other systems, in a traceable and tamper-proof manner. DLT systems are known from the state of the art, for example DLT systems that work on the basis of the blockchain method.

According to the invention, a DLT system is used to mint and manage NFTs corresponding to vehicle function schemes, which system is set up to assign at most one vehicle to an NFT at a specific point in time. Of course, several NFTs can also be assigned to a vehicle function scheme, which are therefore in principle functionally identical (i.e., configuring a vehicle in the same way) and can be assigned to different vehicles. Thus, depending on the number of NFTs minted for a vehicle function scheme, only one single vehicle or any other limited number of vehicles can be assigned to this particular vehicle function scheme.

At least one NFT is selected and/or purchased for a vehicle from the set of NFTs registered in the DLT system. The vehicle function scheme assigned to this selected and/or purchased NFT is used on the vehicle.

The method according to the invention makes it possible to control the distribution of vehicle function schemes and to create a digital marketplace for trading them. In particular, unauthorized dissemination of vehicle function schemes is prevented by the forgery-proof assignment to in each case at most one vehicle in the DLT system. This promotes the development and further development of such vehicle function schemes, achieves an exclusive perception of certain vehicle functions and generates additional added value from the trade in vehicle function schemes.

A vehicle function scheme is understood here and in the following to mean a configuration, i.e., a set of parameters and/or functional settings of a vehicle function.

In one embodiment, a vehicle function scheme records parameters of a visually perceptible staging of a vehicle interior. Such parameters can, for example, relate to interior lighting for a vehicle and can be set in such a way that a specific color, brightness and/or brightness distribution that triggers a special user experience is or are generated. Alternatively or additionally, such parameters can also configure background images or background patterns to be shown on one or more displays in the vehicle interior. Visually perceptible staging is particularly easy to personalize and offers a high level of recognition.

In a similar way, a vehicle function scheme can parameterize the audio playback in the vehicle interior, for example with regard to the absolute and/or frequency-dependent relative volume or with regard to certain sound effects. For example, preferred audio playback settings can be parameterized in a vehicle function scheme as a function of an audio source (e.g., radio or external media) or as a function of an audio characteristic (e.g., speech, classical music, or rock music). Sound effects can also be parameterized, which are generated for perception in the immediate vehicle surroundings, for example an artificial engine sound for an electrically powered vehicle.

In one embodiment, an NFT comprises requirement data and parameter data, wherein the parameter data describes the settings of the vehicle function scheme and wherein the requirement data describes those equipment features of the vehicle that are required for the implementation of a vehicle function scheme according to the parameter data.

Typically, an NFT has a transaction-variable cryptographic hash value, which contains both features of the protected digital asset (in this case parameters of a vehicle function scheme) and features of one or more transactions with this digital asset, for example timestamps of a transfer of ownership or usage rights. Such hash values determined over the entire digital asset are therefore unsuitable for a search, even if they relate to one and the same setting of a vehicle function scheme, as they are changed in an unpredictable manner in the course of the transactions.

In the present embodiment, such a transaction-variable hash value of an NFT is formed only based on the parameter data and supplemented by a transaction-invariant part comprising the requirement data. In an advantageous manner, the transaction-invariant part can be used to search for those NFTs that can be implemented on a vehicle with given specific equipment features. At the same time, the cryptographic security of the vehicle function scheme settings to be protected is not compromised as a result.

In one particularly advantageous embodiment, the requirement data comprises an optional equipment code (SA code) and/or a hardware version and/or a software version of an equipment feature. Therefore, a particularly simple and specific search for NFTs which are suitable for a specific vehicle is possible.

In one embodiment of the method, for at least one NFT registered in the DLT system, its compatibility with a known vehicle is determined using the identity of this vehicle. The identity of a vehicle can be specified, for example, by a number or character string, referred to as a Vehicle Identification Number (VIN), which is unique at least for the fleet of vehicles of a vehicle manufacturer.

By means of this embodiment, only those vehicle function schemes are offered and/or provided for a vehicle, which are compatible with the equipment features of the vehicle, i.e., can be used and implemented with the hardware and software components of the vehicle. Therefore, the vehicle is easier to configure.

In one embodiment, a selection list is created and is stored in at least one head unit of a vehicle, which selection list comprises the NFTs compatible with this vehicle and registered in the DLT system. A head unit is to be understood here and in the following as a central control unit which has a user interface and with which vehicle functions, in particular settings in the vehicle interior and/or infotainment functions, can be controlled.

With this embodiment, a selection of NFTs can be executed particularly quickly and autonomously i.e., without repeated access to the DLT system.

In a further embodiment, equipment features are assigned to a vehicle in a configuration management system and stored there. Such equipment features may, for example, but not exclusively, relate to compatibility with vehicle function schemes of NFTs. For example, a hardware configuration installed in the vehicle for an interior lighting system for a vehicle and a software version installed on it may be recorded.

According to this embodiment of the method, a list of all NFTs registered in the DLT system is created and at least one NFT is selected from this list. For the at least one selected NFT, its compatibility with the vehicle is determined by means of the configuration management system.

With this embodiment, it is achieved that only those NFTs are selected for a vehicle whose assigned vehicle function schemes can be implemented in the vehicle. This allows for particularly good usability and prevents inappropriate NFTs from being purchased.

In a further embodiment, a selection list is created for a vehicle of those NFTs registered in the DLT system that are compatible with the respective vehicle (i.e., with its equipment features). Such a selection list, also called whitelist, is offered for the selection of one or more compatible NFTs. This makes it easier for the user to select NFTs.

Preferably, a selection list generated in this way is stored locally in the vehicle in one or more head units and reused for a subsequent selection of NFTs. By not having to re-generate such a selection list for each selection process, but only at longer intervals, the selection process is accelerated and usability is improved.

In a further embodiment, a first hash value based on the requirement data that describe the equipment features needed to implement the settings of the vehicle functional scheme associated with this NFT, for example as a set of SA codes, is generated for each NFT. Furthermore, a second hash value based on the settings of the vehicle function scheme is generated. A first list comprising the first hash values is created and stored locally in a vehicle. Furthermore, a second list comprising the second hash values is created and stored in a distributed system independent of a vehicle, preferably in a cloud.

When retrieving an NFT for a particular vehicle, the first NFTs that can be implemented on the vehicle are selected based on the first list stored locally in the vehicle and their first hash values are extracted. Then, the respectively assigned second hash values are searched for and extracted on the basis of the second list stored in a distributed manner and preferably in the cloud, which hash values describe the assigned settings of the vehicle function scheme.

The first and the respectively assigned second hash value are combined and checked for correct assignment by means of a test algorithm. If correctly assigned, the NFT is retrieved from the DLT system on the basis of the value combined from the first and second hash values.

According to a second aspect of the invention, an apparatus for carrying out the method according to the first aspect of the invention comprises at least one DLT system, which is set up for access via an Over-The-Air network, preferably via a mobile radio network.

This makes it possible to execute the method almost independently of the location of the vehicle. Further advantages of the apparatus correspond to the advantages of the method according to the first aspect of the invention.

### BRIEF DESCRIPTION OF THE DRAWING FIGURES

Exemplary embodiments of the invention are explained in more detail in the following using the drawings, in which:

FIG. 1 schematically shows the design of a non-fungible token (NFT),

FIG. 2 schematically shows a process sequence for the transmission of an NFT between a distributed ledger technology (DLT) system and a vehicle,

FIG. 3 schematically shows the access to a DLT system of vehicles,

FIG. 4 schematically shows the method for restricting access to vehicle settings, which are protected by means of NFTs,

FIG. 5 schematically shows the process sequence for the selection of an NFT for a vehicle,

FIG. 6 schematically shows the process sequence for the selection of an NFT for a vehicle using NFT hash values, and

FIG. 7 schematically shows the sequence of a transaction for the transmission of an NFT between two vehicles.

Parts corresponding to each other are provided with the same reference signs in all the figures.

### DETAILED DESCRIPTION

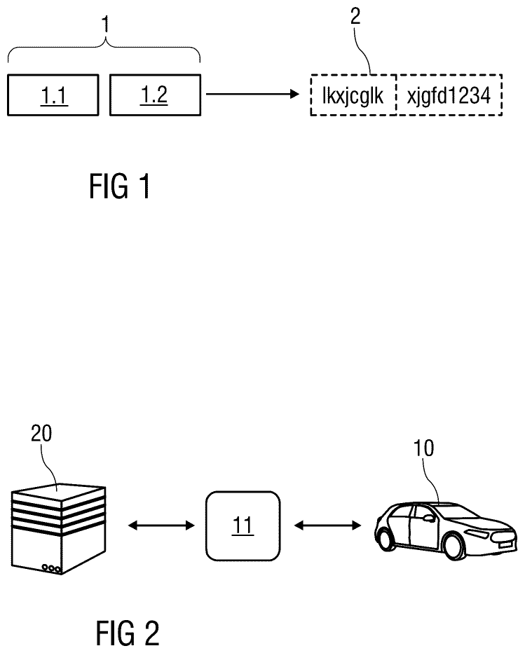

FIG. 1 schematically shows the design of a non-fungible token (NFT) 1 for configuration of vehicle functions, for example for configuring a color scheme for an interior lighting system for a vehicle or for configuring a sound or audio scheme for an audio system. The NFT 1 comprises data, preferably characters arranged in a character string, control instructions, and/or numbers.

In a first section, the NFT 1 comprises requirement data 1.1, using which the technical implementation of a configuration specified by the NFT 1 (i.e., of a vehicle function scheme, in relation to a specific function) can be checked. Requirement data 1.1 can, for example, comprise one or more optional equipment codes (SA codes). Specific, optional, for example country-specific or region-specific, equipment features of a vehicle, not shown in detail in FIG. 1, are identified with an SA code. Alternatively or additionally, the requirement data 1.1 can identify development stages of sub-systems of the vehicle, for example a hardware version and/or a software version.

In a second section, the NFT 1 comprises parameter data 1.2 specifying settings for specific functions available in a vehicle that fulfill the requirement data 1.1. For example, the lighting of a vehicle interior can be configured by means of such parameter data 1.2 in such a way that specific colors or sequences of colors are represented. Additionally, the lighting can be changed depending on operating states of the vehicle (for example, speed, acceleration, or braking) or on another vehicle or multimedia function set by a user of the vehicle. For example, a lighting scheme can be set depending on music selected by the user from an infotainment system.

In an analogous manner, audio or sound functions of the vehicle can be configured. Vehicle seats can also be changed in their position and therefore be adjusted to specific preferences of a user.

Specific graphics or illustrations to be displayed on one or more display devices available in the vehicle can also be specified by means of the parameter data 1.2. Background lighting for such display devices can also be specified by means of the parameter data 1.2.

Furthermore, light effects, for example a light show when opening a vehicle door or the illumination of a logo or brand plate, and/or sound effects, for example an engine noise of an electrically driven vehicle, can be configured by means of the parameter data 1.2.

An NFT hash value 2, which can be represented as a character string and/or integer, is assigned to an NFT 1 via a cryptographic hash function. In particular, a hash function that is collision-resistant and a one-way function is cryptographic (or cryptological). Thus, no other NFT 1 can be determined with realistically available computing power that leads to the same NFT hash value 2 as a different first NFT 1. Similarly, no NFT 1 can be determined with realistically available computing power that results in a predetermined NFT hash value 2 using this cryptographic hash function.

Subsequently, the NFT hash value 2 can be transmitted and/or stored in place of the NFT 1. Preferably, the cryptographic hash function is selected so that certain particularly significant features of the requirement data 1.1 and/or parameter data 1.2 can be taken from the NFT hash value 2, for example restrictions with regard to the technical application of the NFT 1 (for example, a minimum hardware and/or software version).

In one embodiment, it is possible to break down the character string of the NFT hash value 2 into substrings, in order to store them at different points, for example in a vehicle and on a central software system, not represented in detail in FIG. 1.

FIG. 2 illustrates the method of transmitting an NFT 1 between a distributed ledger technology (DLT) system 20 and a vehicle 10. The vehicle 10 has at least one infotainment device, referred to as a head unit 11, which is set up for data exchange, in particular via a wireless Over-The-Air (OTA) network, not shown in detail in FIG. 2, with the DLT system 20 and which can be operated via a user interface by a vehicle occupant.

The head unit 11 controls functions of the vehicle 10, for example lighting functions of an interior lighting system for a vehicle, the audio playback of an audio system in the vehicle interior, a sound generator for creating artificial engine noise for a vehicle having an electric drive, or actuators for adjusting vehicle seats in the vehicle 10, typically involving further control devices, not represented in detail in FIG. 2.

The DLT system 20 can, for example, be designed as a blockchain and is set up to manage a plurality of NFTs 1. In particular, the DLT system 20 is set up to individualize NFTs 1 managed therein in a tamper-proof and forgery-proof manner, i.e., to assign them to a specific user. The functioning of the DLT system 20 is explained even more precisely in the following.

A list of NFTs 1 can be displayed to a user (i.e., a driver or other vehicle occupant of the vehicle 10) by means of a preferably graphic operating interface of the head unit 11, the assigned configurations of which NFTs can be implemented on the vehicle 10.

For this purpose, a vehicle identification number (VIN) can be transmitted to the DLT system 20 by the head unit 11. Using a further vehicle configuration information system, not represented in detail in FIG. 2, those NFTs 1 that can be technically executed on the vehicle 10 (with the available hardware and software configuration) can be selected using such a VIN and sent to the vehicle 10. Alternatively, relevant information and parameters can also be directly transmitted to the DLT system 20 for selecting NFTs 1.

In one embodiment, an NFT hash value 2 can be used as an index, by means of which a set of parameters and/or a specified algorithm, encoded for example as a program, for evaluating these parameters can be clearly determined, for example can be downloaded from a cloud server. The parameters and/or the algorithm are loaded into the local storage device of the head unit 11. The head unit 11 determines therefrom a setting of vehicle functions, for example the control of light sources of different colors for illuminating the vehicle interior for imparting a predetermined perceptible color impression.

In one embodiment, a list of NFTs 1 technically suitable for the respective vehicle 10 is displayed on the operating interface for selection and/or saved on a data storage device. A user can activate a corresponding NFT 1 for their vehicle 10 (i.e., set vehicle functions of the vehicle 10 according to the parameters set in the selected NFT 1) by selecting from this list. Typically, to do this, it is necessary to purchase a selected NFT 1 before use, for example by an e-commerce transaction over a wireless network.

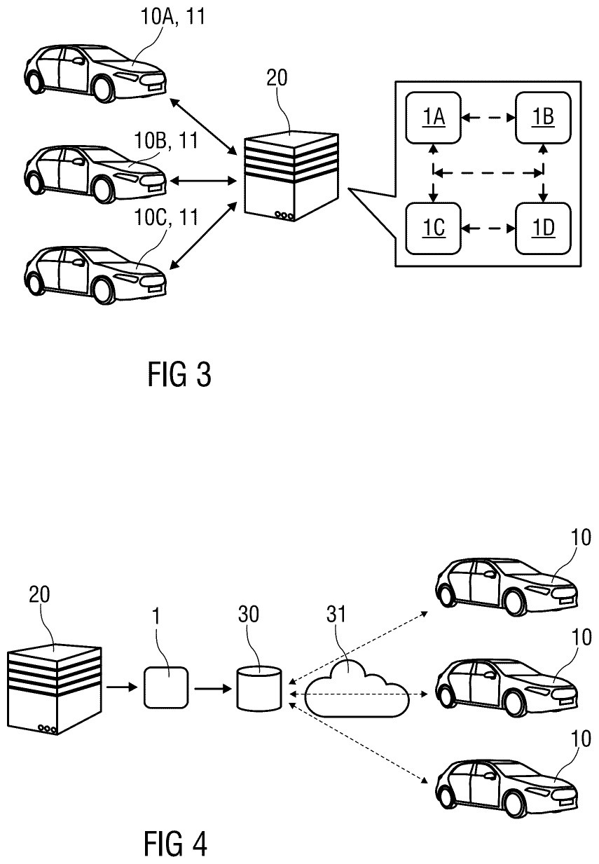

The invention is based on the fundamental idea that configurations parameterized via NFTs 1 are not used on any random number of vehicles 10, but can be used in a unique (i.e., on a single vehicle 10) or limited manner (i.e., at most on a predetermined number of vehicles 10), regardless of the number of vehicles 10 that would be technically set up and prepared for the use of such an NFT 1. For such a limitation, the individualization of NFTs 1 is first required, which is explained more precisely using FIG. 3.

FIG. 3 schematically shows three different vehicles 10A to 10C, having, in each case, at least one head unit 11 that access the DLT system 20 independently of each other. The DLT system 20 manages four NFTs 1A to 1D, which encode a specific configuration or parameterization for a vehicle 10 in the same manner. For example, identical settings for an interior lighting system for a vehicle can be specified by each of the four represented NFTs 1A to 1D.

In addition, these four NFTs 1A to 1D encode the technical requirements necessary to implement the configuration specified therein, for example a certain type and an at least one stage of development of an interior lighting system for a vehicle as a hardware version and at least one software version of a head unit 11. It is possible that the configuration encoded in the NFT 1A to 1D can be implemented with vehicles 10A to 10C of different types or different development stages.

The represented NFTs 1A to 1D are thus functionally identical, in other words: each of the four NFTs 1A to 1D, when it is set up on a vehicle 10A to 10C suitable for this purpose due to its type and development stage, leads to an identical user perception, for example to a certain, typical interior lighting. Certainly, the configuration encoded by an NFT 1A to 1D is not restricted to a visual user perception; settings of an audio system, or settings on one or more vehicle seats or combinations of such settings can also be encoded. The user perception that can be associated with an NFT 1A to 1D is only limited by the technical parameters of the vehicle 10A to 10C, which can be influenced by the head unit 11 or downstream control units. However, the functionally identical NFTs 1A to 1D have different identities, which, for example, can be specified by different assigned integer values or character strings in the form of globally unique identifiers (GUI).

Each of the functionally identical NFTs 1A to 1D is either individualized, i.e., assigned to a vehicle 10A to 10C, or registered as still available, by means of the DLT system 20. For example, a first NFT 1A can be assigned to a first vehicle 10A, a second NFT 1B can be assigned to a second vehicle 10B, and a third NFT 1C can be assigned to a third vehicle 10C, using the respective VIN, and a fourth NFT 1D can be registered as still available and can be offered to other users for purchase.

Both the transition of an already assigned NFT 1A to 1C (i.e., assignment to another VIN), as well as the purchase of a not yet assigned NFT 1D (i.e., the first assignment to a new VIN) is registered and managed by the DLT system 20. In this manner, limited circulation of functionally identical NFTs 1A to 1D can be implemented, as in the present case, for example, in the scope of four functionally identical NFTs 1A to 1D. The amount (the scope) of a limited circulation, can be arbitrarily set by the operator of the DLT system 20, which issues the NFTs 1A to 1D, and can also be one, for example. In this case, only one single NFT 1 of a certain configuration (associated with a certain user experience) can be assigned to a vehicle 10A to 10C.

To enforce limited circulation of a certain parameterization of vehicle functions, limitation of access to this parameterization is required alongside the individualization of the NFTs 1A to 1D assigned to this parameterization. In other words: only those vehicles 1A to 1C on which (based on their VINs, for example) one of these NFTs 1A to 1D is registered in the DLT system 20 should be able to make settings (for example, for the color design of the lighting of the vehicle interior and/or for influencing the audio playback) according to this parameterization. FIG. 4 illustrates the functioning of the limitation of such type.

Vehicles 10, for which certain settings are to be made (for example for the vehicle interior lighting), ask a central configuration management system 30 for authorization for this, preferably indicating the respective VIN. The vehicles 10 are connected to the configuration management system 30 via a wireless Over-The-Air (OTA) network 31.

The configuration management system 30 determines whether the requested parameterization, (i.e. the entirety of all settings required for creating the specific user experience) are assigned to an NFT 1, which has been registered in the DLT system 20 for a vehicle 10 or for several vehicles 10A to 10C. If no such assignment is registered, any vehicle can perform and use the requested settings.

If, conversely, one or more NFTs 1 are assigned to the requested parameterization, the configuration management system 30 checks whether the identity of the requesting vehicle 10 matches with the identity of one holder or with the identities of several holders of NFTs 1 issued for the requested settings. For example, it can be checked whether one of the NFTs 1 in question has been issued to the VIN of the requesting vehicle 10.

If a match is found, the parameters and/or the algorithm for the requested parametrization are transmitted to the head unit 11, not further illustrated in FIG. 4, of the requesting vehicle 10, which determines therefrom the specific instructions and parameters required to set the vehicle functions and implements them in the vehicle 10.

If none of the NFTs 1 created for the requested parameterization has been issued to the requesting vehicle 10, the transmission of the parameters or the algorithm is refused. In this case, the requesting vehicle 10 cannot perform the parameterization. Thus, it is ensured that parameterization is reserved exclusively for those vehicles 10 that have been assigned a corresponding NFT 1.

As already explained, the technical implementation of the vehicle settings encoded in an NFT 1 can be linked to technical prerequisites, which are not specified in each vehicle 10 of a vehicle type, for example linked to a specific hardware configuration and/or a version status of firmware for an interior lighting system or for an audio system. In the following, FIG. 5 explains more precisely how to select an NFT 1 that is suitable for a particular vehicle 10 (i.e., whose encoded settings are implementable on the vehicle 10).

In a first step S1, a vehicle 10 (comprising a head unit 11, not shown in detail in FIG. 5) shares its VIN via an OTA network 31 with a configuration management system 30, in which the equipment features of the vehicle 10 are recorded. In a second step S2, the configuration management system 30 determines the entirety of equipment features (for example, hardware and software configurations of an interior lighting system and/or an audio system) assigned to the shared VIN.

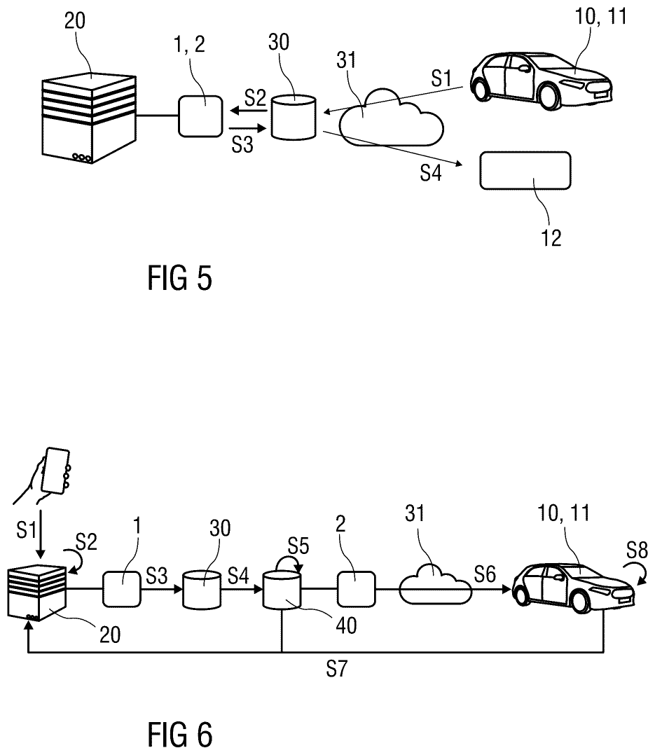

In a third step S3, the configuration management system 30 sends a request to the DLT system 20 to determine those NFTs 1 registered there that are compatible with the equipment features of the vehicle 10. Alternatively or additionally, it is also possible to transmit the NFT hash values 2 respectively assigned to the selected NFTs 1 to the vehicle 10. This embodiment is subsequently explained even more precisely using FIG. 6.

In a fourth step S4, this vehicle-specific selection of NFTs 1 is transmitted via the OTA network 31 to the vehicle 10 and is shown there on a display 12 (which, for example, can be assigned to the head unit 11).

For the representation on the display 12, it is necessary to determine the essential features of each NFT 1 of this vehicle-specific selection. This can take place by decoding the respective NFT 1 or using the assigned NFT hash value 2.

FIG. 6 illustrates an embodiment of a method more precisely, in which a selection of suitable NFTs 1 is made in a vehicle 10 using the NFT hash values 2 of the NFTs.

In a first step S1, settings of vehicle functions, preferably settings in relation to the vehicle interior, are developed, which convey a particularly pleasant or original user experience, for example. These settings can be developed by the manufacturer of the vehicle 10, but also by a service provider, a supplier or a third-party not involved in the manufacture of the vehicle 10.

In a second step S2, an NFT 1 or a predetermined, limited number of NFTs 1 is minted from the developed vehicle settings (i.e., the parameters or configuration of vehicle functions) on a DLT system 20 via a cryptographic process.

In a third step S3, the at least one NFT 1 assigned to the developed vehicle settings is transmitted to the configuration management system 30 on which the equipment features of the vehicles 10 of a fleet and/or a manufacturer are registered on the basis of their respective VINs.

In a fourth step S4, the configuration management system 30 determines the VINs of those vehicles 10 whose equipment features are compatible with the developed vehicle settings (which were assigned to the at least one NFT 1 when it or they were minted). If at least one compatible vehicle 10 is determined, the at least one NFT 1 is transmitted to an NFT hash converter 40.

In a fifth step S5, the NFT hash value converter 40 assigns an NFT hash value 2 to each NFT 1 in such a way that the NFT hash value 2 contains a character string describing the function or the triggered user experience of the respective NFT 1. For example, an NFT hash value 2 could be generated as the character string ‘XXXXLIGHTINGXXX284UR’ for an NFT 1 with a particular vehicle light setting.

In a sixth step S6, the generated NFT hash value 2 is sent via an OTA network 31 to a vehicle 10 whose equipment features are compatible with the settings of the assigned NFT 1. In the vehicle 10, the NFT hash value 2 can be added to a selection list (whitelist) that includes all settings available on the DLT system 20 for this vehicle 10 that are protected via NFTs 1.

In one embodiment, instead of the complete NFT hash value 2, only a part of it can be stored locally in the vehicle 10, with which the function and optionally other parameters, for example the required equipment features or the amount of a limited edition, are described.

A user can select settings of interest to them from such a selection list and purchase an assigned NFT 1 from the DLT system 20. When an NFT 1 is purchased, the VIN of the vehicle 10 is assigned in a seventh step S7 in the DLT system 20. This assigns the configuration associated with the NFT 1 (for example, setting of the interior lighting for the vehicle) to this individual vehicle 10.

The user can then activate the settings of this NFT 1 in an eighth step S8. As already explained with reference to FIG. 4, a check is made during activation as to whether the identity (i.e., the VIN) of the vehicle 10 matches that of the vehicle 10 or one of the vehicles 10 for which a corresponding NFT 1 has been registered in the DLT system 20.

In an alternative or additional embodiment, instead of a selection list (whitelist), a negative list (blacklist) of those NFTs 1 for which the vehicle 10 is not compatible (i.e., does not have the required equipment features) can be created and stored on this vehicle 10.

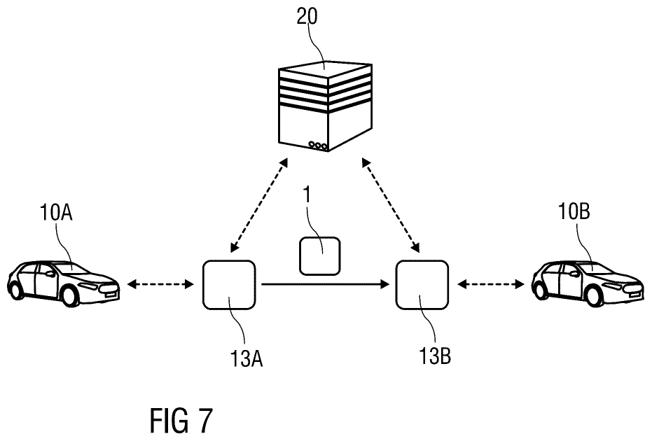

FIG. 7 schematically shows the sequence of a transaction in which an NFT 1 is transmitted from a first vehicle 10A to a second vehicle 10B. Each of the vehicles 10A, 10B is assigned a user account 13A, 13B in the DLT system 20.

Before the transaction is executed, an NFT 1 is registered in the DLT system 20 for the first vehicle 10A. This means that the settings assigned to this NFT 1 can be activated and made on the first vehicle 10A.

For simplification, the case where only a single and therefore exclusive NFT 1 has been minted for the assigned settings is shown first. In this case, it is not possible for anyone else, including the second vehicle 10B, to use these settings.

During the transaction, the NFT 1 is transmitted to the second vehicle 10B against payment of an agreed purchase price. The transaction (i.e., the reassignment of a vehicle identity, typically a VIN, to the NFT 1) is registered in the DLT system 20. After the transaction, the assigned settings are deactivated on the first vehicle 10A and can be activated on the second vehicle 10B.

The user accounts 13A, 13B are used to assign one or more vehicles 10, 10A to 10C to a user, i.e., to a natural or legal person with ownership rights to the respective vehicle 10, 10A to 10C. Furthermore, the user accounts 13A, 13B may be used to process business transactions, such as the described sale and purchase of NFTs 1. The operator of an NFT marketplace through which these transactions are processed and to which the user accounts 13A, 13B provide access may charge fees for the transactions with or for the management of NFTs 1. Preferably, such an NFT marketplace will be accessible to smartphones or web browsers from computer workstations.

Such a sales transaction can also be carried out in the event that not just a single (exclusive) NFT 1, but a limited number of NFTs 1 relating to certain vehicle settings, such as a color scheme for the vehicle interior lighting, have been minted. In this case, a buyer can choose from potentially several suppliers of NFTs 1 that are identical in terms of vehicle settings but individually distinguishable and potentially also offered with different conditions.

It is also possible for NFTs 1 to be acquired by legal entities or natural persons with a user account 13A, 13B without being assigned to a vehicle 10, 10A to 10C at the same time. For example, a vehicle manufacturer can purchase or buy back NFTs 1 in order to offer them again.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-11. (canceled)

12. A method for individually assigning at least one vehicle function schema, describing a configuration of at least one vehicle function, to a vehicle, the method comprising:
digitally recording and minting the at least one vehicle function schema as a non-fungible token (NFT) in a predetermined number in a distributed ledger technology (DLT) system, wherein the DLT system assigns the NFT to the vehicle and the NFT is assigned to at most one vehicle;
selecting or acquiring at least the NFT for the vehicle; and
applying, based on the selected or acquired NFT, an assigned vehicle function schema to the vehicle,
wherein the NFT encodes technical requirements required to implement a configuration of the at least one vehicle function, wherein the configuration is described by the assigned vehicle function schema, and
wherein the NFT comprises requirement data and parameter data, wherein the parameter data describes settings of the at least one vehicle function schema, and the requirement data describes equipment features of the vehicle required to implement the at least one vehicle function schema according to the parameter data.

13. The method of claim 12, wherein the requirement data comprises a special equipment code, a hardware version, or a software version of at least one of the equipment features.

14. The method of claim 12, wherein the vehicle function schema records parameters of visually perceptible staging of a vehicle interior of the vehicle.

15. The method of claim 12, wherein the vehicle function schema records parameters of audio or sound playback in an interior or in surroundings of the vehicle.

16. The method of claim 12, wherein, the NFT is registered in the DLT system, the method further comprising:
determining, using an identify of the vehicle, a compatibility of the NFT with the vehicle.

17. The method of claim 12, further comprising:
determining a selection list of NFTs compatible with the vehicle; and
offering the vehicle at least one NFT in the selection list of NFTs for selection.

18. The method of claim 17, wherein the selection list of NFTs compatible with the vehicle is stored in at least one head unit of the vehicle.

19. The method of claim 16, further comprising:
assigning, by a configuration management system, equipment features assigned to a vehicle and storing the assignment;
creating a list of all NFTs minted in the DLT system;
selecting at least one NFT from the list of all NFTs; and
determining, by the configuration management system for the at least one selected NFT, a compatibility with the vehicle.

20. The method of claim 19, further comprising:
assigning each NFT of the list of NFTs a first hash value based on requirement data and a second hash value based on parameter data is assigned to each NFT of the list of NFTs;
creating and locally storing in the vehicle a first list comprising the first hash values; and
creating and storing in a cloud a second list comprising the second hash values is created and distributed and is stored in a cloud in a distributed manner,
wherein the parameter data describes the settings of the vehicle function schema, and
wherein the requirement data describes the equipment features of the vehicle required for implementing the vehicle function schema according to the parameter data.

21. An apparatus configured to perform the method of claim 12, the apparatus comprising:
at least one DLT system configured for access via an Over-The-Air (OTA) network.
